(19) United States
(12) Patent Application Publication
(10) Pub. No.: US 2014/0317055 A1
(43) Pub. Date: Oct. 23, 2014

(54) Version Vector Scheme for Data Synchronization on Resource-Constrained Networks

(71) Applicant: NEC Laboratories America, Inc., Princeton, NJ (US)

(72) Inventors: Nitin Agrawal, East Brunswick, NJ (US); Akshat Aranya, Jersey City, NJ (US); Cristian Ungureanu, Princeton, NJ (US)

(73) Assignee: NEC Laboratories America, Inc., Princeton, NJ (US)

(21) Appl. No.: 14/251,200

(22) Filed: Apr. 11, 2014

Related U.S. Application Data
(60) Provisional application No. 61/810,806, filed on Apr. 11, 2013.

(51) Int. Cl. G06F 17/30

(52) U.S. Cl. CPC G06F 17/30176; G06F 17/30038
USPC 707/627

(57) ABSTRACT

Disclosed herein are methods and structures for networks of mobile computers which efficiently synchronizes table data across the mobile computers while exhibiting great tolerance for temporary disconnects.

### CROSS REFERENCE TO RELATED APPLICATIONS

This application claims the benefit of U.S. Provisional Patent Application Ser. No. 61/810,806 filed Apr. 11, 2013 which is incorporated by reference in its entirety as if set forth at length herein.

### TECHNICAL FIELD

This disclosure relates generally to the field of mobile computing and applications pertaining thereto. More specifically, this disclosure describes pertains to data synchronization on resource-constrained networks and in particular to data synchronization among and between mobile devices.

### BACKGROUND

As is known, applications that execute on mobile devices (mobile apps) frequently need to transfer data to/from cloud resources and to/from other mobile devices that may be executing those applications. As may be appreciated, synchronizing that data among and between the mobile apps and the cloud resources presents a number of problems. Accordingly—and given the pervasiveness and importance of such mobile apps in contemporary society—methods and structures that facilitate such transfer and synchronization would represent a welcome addition to the art.

### SUMMARY

An advance in the art is made according to an aspect of the present disclosure directed to methods and structures for networks of mobile computers which efficiently synchronizes table data across the mobile computers while exhibiting great tolerance for temporary disconnects of the mobile devices from the network. Our method—which we call mobile friendly-version vectors (MFVV), advantageously achieves consistent synchronization in the mobile environment through careful management of per-row and per-table metadata.

### BRIEF DESCRIPTION OF THE DRAWING

A more complete understanding of the present disclosure may be realized by reference to the accompanying drawings in which:

FIG. 1 shows in schematic form a table used in synchronization according to an aspect of the present disclosure;

FIG. 2 shows in schematic form tables used in synchronization among and between mobile clients and cloud services according to an aspect of the present disclosure; and

FIG. 3 shows a schematic block diagram of an illustrative computer system on which aspects of the present disclosure may be operated and/or executed.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope. More particularly, while numerous specific details are set forth, it is understood that embodiments of the disclosure may be practiced without these specific details and in other instances, well-known circuits, structures and techniques have not been shown in order not to obscure the understanding of this disclosure.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

In addition, it will be appreciated by those skilled in art that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

Thus, for example, it will be appreciated by those skilled in the art that the diagrams herein represent conceptual views of illustrative structures embodying the principles of the disclosure.

By way of some additional background, it is noted that contemporary society make extensive use of mobile apps that transfer/synchronize data with cloud entities and/or services as well as other mobile clients executing those apps. Oftentimes however, apps that transfer/share/synchronize data among and between a plurality of mobile clients executing those apps must individually provide synchronization mechanisms including managing data transfers, handling network and other failures and/or crashes, and even more onerous—detecting and resolving conflicts and propagating changes to other users/clients in a timely manner.

Compounding these problems is a strong desire to make efficient usage of any network resources. More particularly, individual apps may transfer data frequently—even those that only transfer a small amount of data at a time—such that cellular radio is operational for extended periods and uncoordinated transfers among and across apps further increase those periods.

Contemporary schemes for synchronization among and between mobile Apps—while tolerant of temporary network disconnections or outages—nevertheless assume plentiful bandwidth when network connectivity is restored. Such an assumption is not necessarily true for 3G/4G cellular networks as such networks are constrained by bandwidth. Additionally, users of 3G/4G networks are oftentimes capped with respect to the amount of data transferred during a billing period.

Motivated by these deficiencies in the art and coupled with the realization that mobile networks experience frequent disconnections and limited bandwidth we disclose methods and structures—mobile-friendly version vectors (MFVV)—which more efficiently synchronizes table data in networks of mobile devices and applications executing thereon.

According to an aspect of the present disclosure, MFVV to achieves data synchronization in mobile environments while being frugal with the number of network messages that are exchanged among/between mobile clients and cloud entities. An exemplary implementation of MFVV is in the context of a cloud system called Mobius that advantageously allows mobile clients to keep data synchronized with a cloud storage system, and with other mobile clients.

As may become apparent, MFVV is a variant of version vectors that provides concurrency control with eventual consistency semantics, where the eventual repair is done lazily by a mobile client app. Notably, the current, illustrative embodiment of MFVV is in a table-synchronization system called Mobius; the current MFVV versioning schema thus alludes to tables, rows, and columns.

In a non-blocking sync environment (e.g., Mobius), a mobile client can continue to perform updates and queries on a local data store while updates and queries to a cloud store are still outstanding. Advantageously, table rows may include changes made to data entries which are successively modified again. For example, after sending a write to a row to be synced to the server, the client can make one or more updates to the row without being aware of any conflicts on the server.

As may be appreciated, while this disclosure is presented in the context of mobile devices, our MFVV method and systems are not so limited and are applicable for any environment where network connectivity is limited, frequently disconnected, expensive, or any combination of the above. Additionally, while the disclosed illustrative implementation relies on a table schema with columns to store the metadata, our disclosed methods and structures—in a more general setting such as a distributed file system—can advantageously be employed in conjunction with other suitable data structures.

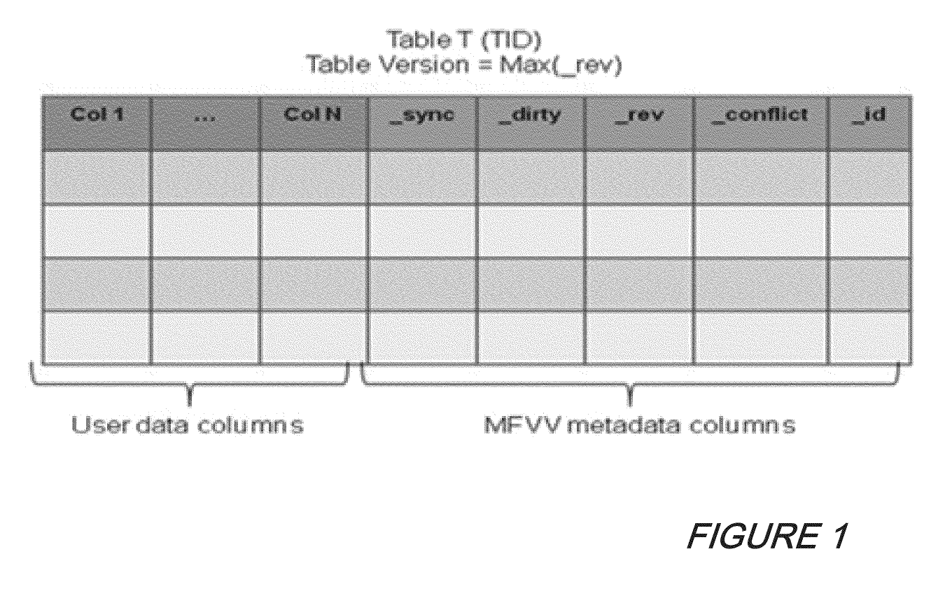

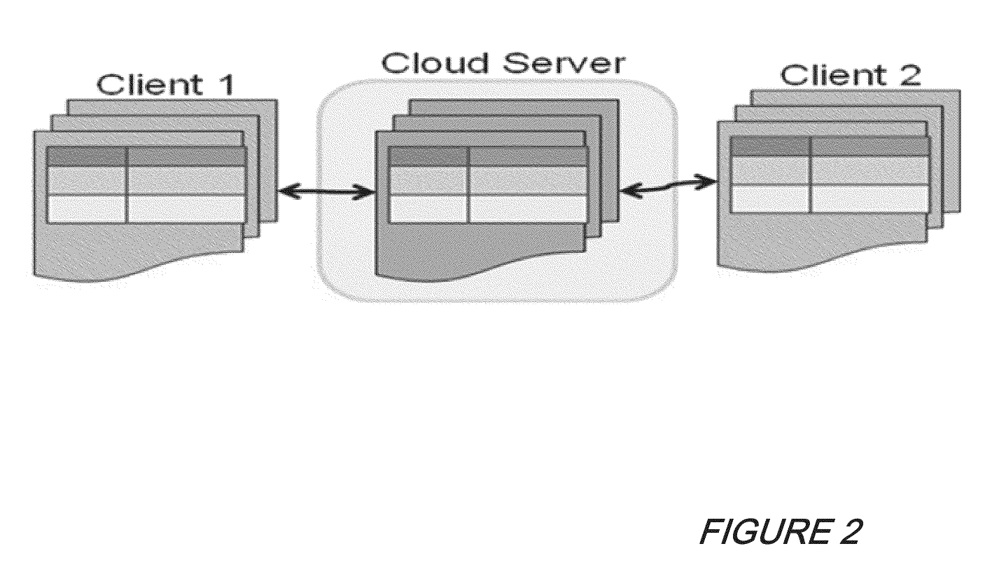

We may now present a more detailed description of our technique and structures according to the present disclosure. With simultaneous reference to FIG. 1 and FIG. 2, which show a modified table according the present disclosure and client synchronization respectively, we note that for a table synchronized using MFVV, in addition to the columns storing application/user data, MFVV adds a few columns to the table schema for storing internal metadata and bookkeeping information. These internal columns—referred to as meta-columns—are not exposed to the application or the user.

The meta-columns are _id, _rev, _dirty, _sync, and _conflict; we now explain their usage in detail. In SQLite, a boolean flag requires only a single bit and is more efficient than a short or integer flag with multiple bit masks; MFVV thus uses separate flags for maintaining the sync status in its current embodiment.

_id

Each row in a table needs to be uniquely identified in order for it to be shared across devices and users. This is achieved in the following ways:
If the table has a primary key, then by definition the primary key column is a unique identifier. MFVV can either use the primary key as the _id, or use a hash of the primary key.
   If primary key is defined over multiple columns, MFVV uses MD5 hash of the primary key.
If the table is without a primary key, MFVV assigns a unique _id.
   The _id is generated at the time the row is created; it can be a Pseudo-randomly generated number or an MD5 hash of the contents of the entire row.
Clients can independently create rows and assign them _id without server mediation; in the case of _id collision (e.g., based on the primary key), a conflict is detected needs to be resolved (explained later).

_rev

To support versioning and allow multiple writers (e.g., multiple mobile clients) to independently update the same row of a table, MFVV also assigns a monotonically increasing version ID (rev) to each row. Through the _rev, a server can efficiently keep track of client state in order to determine what changes need to be synchronized.
In our present design, _rev for a row can be assigned (and updated) only by the cloud server. A newly created row remains version-less until its first sync to the server.
The server assigns the _rev in the following way:
   Each ₜable has a single number to represent current version (_trev)
   On a new row sync to server, _trev is incremented by 1 and assigned to the row
_trev thus represents the most recent version of all its rows; _trev=MAX(_rev)
This versioning scheme is crucial for the server to maintain information about the client with a low overhead per table. By storing _trev which indicates the logical time of the last sync with a client, the server can quickly identify the rows that have been modified since then.
MFVV is designed to allow disconnected operations; the clients should be able to make local updates in absence of connectivity with the server. Local updates on the clients thus do not need changing the _rev, but only when a sync is attempted.

_dirty and _sync

As may be appreciated, since a client can make local changes while sync is pending, a separate flag (_dirty) is needed to indicate whether a row has been locally modified or not.
Prior to a sync operation between the client and the server, the rows with _dirty flag set are collected.
However, the usage of the _dirty flag alone is not sufficient for network sync. A system like Mobius intends to support clients making local updates while older updates are being synced to the server, and vice versa. If a single _dirty flag is used per-row, while the sync is in progress, updates will have to wait. If the network is disconnected or the sync messages are lost, the updates can stall indefinitely.
A separate _sync flag is used solely to indicate whether the row is pending a sync operation; as part of the same transaction for row sync, first the _dirty flag is cleared, and second the _sync flag is set to identify rows that are pending sync with the server. Once the sync operation returns successfully, the _sync flag is cleared; if the row has since been modified and _dirty is set again meanwhile, the row becomes a candidate to be synced again.
   If a sole _dirty flag had been used, it would need to be cleared when sync is initiated. Subsequently, while the sync to the server is pending, if local updates occur, the _dirty flag would be set again; this situation would be indistinguishable from that of a failed sync.
   On the other hand, if the dirty flag is presumed to be cleared on sync completion, local changes will be lost. MFVV is thus specifically designed for mobile clients to make progress while disconnected.
An in-flight sync operation has to return successfully and clear the _sync flag for a set of rows before a subsequent sync is initiated.

_conflict

MFVV is designed for multiple clients potentially making changes to the same set of rows; it must thus be able to identify conflicts and help in their resolution. Accordingly, Detection works as follows:
If the _rev for a row sent by a client equals the server's _rev for that row, it means no other client has submitted concurrent changes. The update is thus accepted and the server's rev is incremented as per the protocol described earlier.
Conflict arises if the client _rev is less than the server's _rev meaning the server has already accepted some other client's changes and moved ahead. The server's _rev should never be less than the client's since the client cannot increment _rev. Conflicts are based on the logical time of update and not based on the actual values of columns in the row.
Client initiated sync operations return either with success or conflict (along with the server's _rev and the server's copy of the data for that row (Ws); correspondingly the _sync flag is cleared or a _conflict flag is set, per row.

In case of a sync returning with conflicts, after MFVV has set the _conflict flag for the rows in question, the client apps are notified through a registered callback. Multiple conflict notifications can be passed onto the app before it initiates resolution
In our current design the application instance running on the client or the end-user is capable of conflict resolution; the server can also resolve conflicts according to pre-specfied policies such as first-writer wins, or last-writer wins.

Resolution works as follows:
Until the conflict for a row is resolved, the _conflict flag remains set.
Rows can continue to be locally updated or deleted but are not synced to the server. Conflict resolution mechanism in MFVV does not block the client or the server from making changes to the table under question, and even to the rows under conflict.
   MFVV does not force the client to resolve a conflict immediately; conflicts can be postponed until the app is ready to resolve them. Conflict Resolution (CR) occurs explicitly within a beginCR( ) and endCR( ) call. Local updates are suspended during CR.
   The client can select either of W2, Ws, or a new value.
   The server's _rev is selected for the row which is then subsequently marked _dirty.
   After the conflict is first received and before it is resolved, the client can continue to update the row; this implies that when the app comes around to conflict resolution, the local value could have changed. As mentioned before, MFVV allows this to preserve the semantics of disconnected operation. Consequently, the client may be presented with a different conflict (W2, Ws) than the one sent by the server (W1, Ws). The client always chooses between its most recent copy of the write (W2) and the conflicted copy from the server; the client is never made to chose between two local writes.
MFVV presents clear semantics to prevent race conditions. We explain this with an example:
   Let the client have an outstanding write to a row (W2), while concurrently a conflict is returned on a previous write (W1, Ws) to the same row. If the client resolves the conflict by selecting either of (W1, Ws), it is immediately clobbered by W2; if however the new write is allowed to go through first, it can be clobbered by W2 or Ws.

As may be appreciated, by reducing the number of network message exchanges needed to achieve data synchronization in mobile environments, MFVV provides at least the following benefits namely, 1) Reduced cost of the mobile data consumption to the end-user; 2) Reduced energy consumption on the mobile device due to reduced network activity; and 3) Reduced load due to frequent message exchanges on the network operator , improving scalability

MFVV also benefits mobile application developers by providing a technique that can be implemented in a cloud system such as Mobius, and is available as a service offered by the underlying platform; each app using Mobius can get the benefits of MFVV without having to individually implement synchronization.

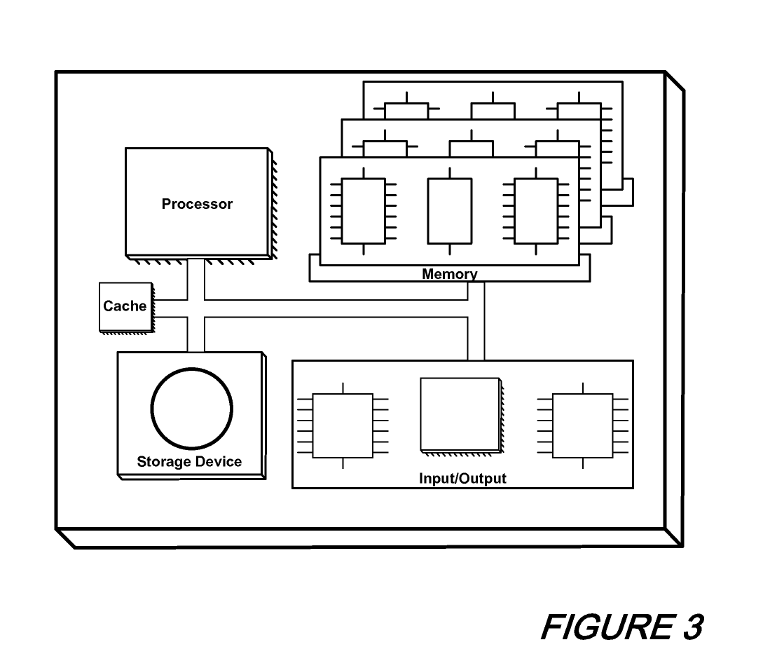

FIG. 3 shows in schematic form an exemplary computer system in which the methods and structures disclosed may be operated. Such exemplary computer includes at least a processor, memory and input/output components which may include programs and systems including wireless interconnect that perform the operations disclosed.

Those skilled in the art will readily appreciate that while the methods, techniques and structures according to the present disclosure have been described with respect to particular implementations and/or embodiments, those skilled in the art will recognize that the disclosure is not so limited. Accordingly, the scope of the disclosure should only be limited by the claims appended hereto.

1. A computer implemented method for version vector data synchronization on resource constrained networks of one or more mobile client devices and a server device, said client devices executing one or more application programs that use data to be synchronized between the client devices and the server, said method comprising the computer implemented steps of :
providing a table of data to be synchronized between a client and the server, said table resident on one or more clients and the server, said table including a number of rows and columns having rows and columns for storing application and user data;
wherein said table includes a set of metacolumns, said metacolumns comprising _id; _rev; _dirty; _sync; _; and _conflict,
assigning a monotonically increasing version ID (_rev) to each row of the table of data; wherein said version ID is provided by the server to the table upon its first synchronization;
tracking, by the server, any rows which need to be synchronized by examination of the version ID; and
synchronizing the table among the client(s) and the server;

2. The computer implemented method according to claim 1 further comprising the computer implemented steps of:
assigning, by the server, a current version (_trev) to each table wherein upon each new row synchronization with server, said _trev is incremented by 1 and assigned to the row so synchronized.

3. The computer implemented method according to claim 2 further comprising the computer implemented steps of:
assigning, by the client, a set value to the dirty flag (_dirty) included in a row when that row is modified by a client; and
collecting any rows with _dirty flag set prior to any synchronization between the client and the server.

4. The computer implemented method according to claim 3 further comprising the computer implemented steps of:
assigning a set value to the _sync flag contained in a row when that row is pending a synchronization operation; and
clearing that _sync flag value upon completion of the synchronization operation.

5. The computer implemented method according to claim 4, further comprising the computer implemented steps of:
determining whether a conflict is present through the use of the _conflict flag by checking the _rev flag for a row sent by a client to determine whether it equals the server“s _rev value for that row, if it does, then no other client has submitted concurrent changes and the row is accepted for synchronization by the server, else if the _rev flag for a row sent by the client is less than the servers rev, then a conflict exists.

6. A computer implemented structure providing a version vector scheme for data synchronization on resource constrained networks, said structure comprising the computer implemented elements of:
a table including a number of rows and columns having rows and columns for storing application and user data;
said table including a set of metacolumns, said metacolumns comprising _id; _rev; _dirty; _sync; _; and _conflict
